(19) United States
(12) Patent Application Publication
(10) Pub. No.: US 2012/0133894 A1
(43) Pub. Date: May 31, 2012

(54) PROJECTION DISPLAY APPARATUS

(75) Inventors: Masafumi Tanaka, Hirakata-City (JP); Shinya Matsumoto, Uji-City (JP); Ryoko Kubo, Ikeda-City (JP); Makoto Maeda, Nara-City (JP)

(73) Assignee: SANYO ELECTRIC CO., LTD., Osaka (JP)

(21) Appl. No.: 13/307,820

(22) Filed: Nov. 30, 2011

(30) Foreign Application Priority Data
Nov. 30, 2010 (JP) 2010-266963

(51) Int. Cl. G03B 31/00

(52) U.S. Cl. 353/15

(57) ABSTRACT

A projection display apparatus is placed on an installation surface forming a horizontal plane and projects an image onto a projection plane provided on a horizontal plane. The projection display apparatus includes: an imager that modulates the light emitted from a light source; an projection unit that projects the light emitted from the imager onto the projection plane; and an acoustic device that outputs a sound in the vertical direction.

### CROSS REFERENCE TO RELATED APPLICATIONS

This application is based upon and claims the benefit of priority from prior Japanese Patent Application No. 2010-266963 filed on Nov. 30, 2010; the entire content of which is incorporated herein by reference.

### TECHNICAL FIELD

The present invention relates to a projection display apparatus including an acoustic device.

### BACKGROUND ART

Conventionally, there is known a projection display apparatus including an imager that modulates light emitted from a light source and an projection unit that projects the light emitted from the imager onto a projection plane.

Further, a projection display apparatus having an acoustic device such as a speaker has also been proposed. More specifically, the acoustic device outputs the sound toward the projection plane which is provided on a vertical plane such as a wall, and the user facing the projection plane hears the sound reverberated by the projection plane.

In recent years, there has been proposed a projection display apparatus that is placed on an installation surface which is forming a horizontal plane such as a floor or a desk top, and that is that projects an image onto the projection plane provided on the horizontal plane. In such a case, it is presumed that the projection display apparatus is placed in a comparatively open space. Further, it is presumed that the projection display apparatus is placed on a confined installation surface such as a desk top. In other words, an application scenario is presumed wherein, two or more projection display apparatuses are placed in spaces partitioned by partitions and where each of these projection display apparatuses projects separate images.

Therefore, there is a possibility that the sounds output from the acoustic devices installed in each of the projection display apparatuses are mixed together.

### SUMMARY OF THE INVENTION

A projection display apparatus (projection display apparatus 100) according to a first feature is placed on an installation surface forming a horizontal plane and projects an image onto a projection plane provided on a horizontal plane. The projection display apparatus includes: an imager (reflective liquid crystal panel 70) that modulates the light emitted from a light source (light source 10); an projection unit (projection unit 310) that projects the light emitted from the imager onto the projection plane; and an acoustic device (acoustic device 330) that outputs a sound in the vertical direction,

In the first feature, the acoustic device outputs the sound by the vibrations of the installation surface.

In the first feature, the projection display apparatus includes a reverberating plate facing the installation surface. The acoustic device outputs the sound generated from the vibrations of a vibration plate by reverberating the sound with the reverberating plate.

In the first feature, the projection unit includes a reflection mirror having a mirror surface for reflecting the light emitted from the imager onto the projection plane side and a rear surface. The acoustic device outputs the sound in the vertical direction by reverberating the sound on the rear surface of the reflection mirror.

In the first feature, the acoustic device, when seen from the front of the projection display apparatus, comprises a first sound output unit provided on the first side-surface side and a second sound output unit provided on the second side-surface side. The sounds output from the first sound output unit and the second sound output unit are mutually independently controlled.

A projection display apparatus (projection display apparatus 100) according to a second feature is placed on an installation surface forming a horizontal plane and projecting an image onto a projection plane provided on a horizontal plane. The projection display apparatus includes: an imager (reflective liquid crystal panel 70) that modulates the light emitted from a light source (light source 10); an projection unit (projection unit 310) that projects the light emitted from the imager onto the projection plane; and an acoustic device (acoustic device 330) that outputs the sound toward the projection plane.

In the second feature, the projection unit comprises a reflection mirror having a mirror surface for reflecting the light emitted from the imager onto the projection plane side. The acoustic device outputs the sound toward the projection plane by reverberating the sound on the mirror surface of the reflection mirror.

In the second feature, the acoustic device directly outputs the sound toward the projection plane without using the reverberation of sound.

In the second feature, the acoustic device, when seen from the front of the projection display apparatus, comprises a first sound output unit provided on the first side-surface side and a second sound output unit provided on the second side-surface side. The sounds output from the first sound output unit and the second sound output unit are mutually independently controlled,

### BRIEF DESCRIPTION OF THE DRAWINGS

FIG. 1 is a diagram illustrating an overview of a projection display apparatus 100 according to a first embodiment.

FIG. 2 is a diagram illustrating the configuration of the projection display apparatus 100 according to the first embodiment.

FIG. 3 is a diagram illustrating an acoustic device 330 according to the first embodiment.

FIG. 4 is a diagram illustrating the acoustic device 330 according to the first embodiment.

FIG. 5 is a diagram illustrating an example of arranging the acoustic device 330 according to the first embodiment.

FIG. 6 is a diagram illustrating an example of arranging the acoustic device 330 according to the first embodiment.

FIG. 7 is a diagram illustrating an example of arranging the acoustic device 330 according to the first embodiment.

FIG. 8 is a diagram illustrating an example of arranging the acoustic device 330 according to the first embodiment.

FIG. 9 is a diagram illustrating the configuration of the projection display apparatus 100 according to a modification 1-1.

FIG. 10 is a diagram illustrating one example of a reflection mirror 312 according to the modification 1-1.

FIG. 11 is a diagram illustrating one example of the reflection mirror 312 according to the modification 1-1.

FIG. 12 is a diagram illustrating one example of the reflection mirror 312 according to the modification 1-1.

FIG. 13 is a diagram illustrating the configuration of the projection display apparatus 100 according to a second embodiment.

FIG. 14 is a diagram illustrating an example of arranging the acoustic device 330 according to the second embodiment.

FIG. 15 is a diagram illustrating an example of volume control according to the second embodiment.

FIG. 16 is a diagram illustrating the configuration of the projection display apparatus 100 according to a modification 2-1.

FIG. 17 is a diagram illustrating a direction in which a sound is output from the acoustic device 330 according to the modification 2-1.

FIG. 18 is a diagram illustrating the configuration of the projection display apparatus 100 according to a modification 2-2.

### MODES FOR CARRYING OUT THE INVENTION

Hereinafter, a projection display apparatus according to embodiments of the present invention is described with reference to drawings. Note that in the descriptions of the drawing, identical or similar symbols are assigned to identical or similar portions.

It will be appreciated that the drawings are schematically shown and the ratio of each dimension are different from the real ones. Therefore, the specific dimensions, etc., should be determined in consideration of the following explanations. Of course, among the drawings, the dimensional relationship and the ratio are different.

### [Overview of Embodiments]

Firstly, a projection display apparatus according to the embodiments is placed on an installation surface forming a horizontal plane and projects an image onto a projection plane provided on the horizontal plane. The projection display apparatus includes: an imager that modulates light emitted from a light source; an projection unit that projects the light emitted from the imager onto the projection plane; and an acoustic device that outputs a sound in the vertical direction.

In the embodiments, since the acoustic device outputs the sound with directing in the vertical direction, the mixing of the sound output from the acoustic devices can be inhibited.

Secondly, the projection display apparatus according to the embodiments is placed on an installation surface forming a horizontal plane and projects an image onto a projection plane provided on the horizontal plane. The projection display apparatus includes: an imager that modulates light emitted from a light source; an projection unit that projects the light emitted from the imager onto the projection plane; and an acoustic device that outputs a sound toward the projection plane.

In the embodiments, since the acoustic device outputs the sound with directing toward the projection plane, the mixing of the sound output from the acoustic devices can be inhibited.

### First Embodiment

### (Overview of Projection Display Apparatus)

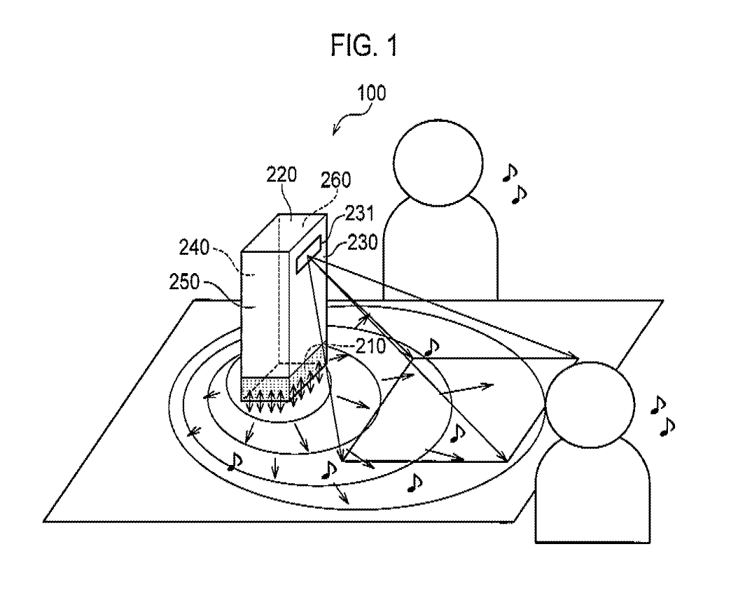

Hereinafter, an overview of the projection display apparatus according to a first embodiment is described with reference to drawings. FIG. 1 is a diagram illustrating a projection display apparatus 100 (floor projection) according to the first embodiment.

As shown in FIG. 1, the projection display apparatus 100 has a casing 200 and projects an image onto a projection plane (not shown). A transmission area 231 through which light emitted from an projection unit 310 described later transmits is installed in the casing 200.

Here, the projection display apparatus 100 placed on a horizontal plane such as a floor or a desk top, projects image light onto the projection plane provided on a horizontal plane such as a floor or a desk top.

In the first embodiment, the casing 200 has a bottom plate 210, a top plate 220, a front plate 230, a rear plate 240, a first side plate 250, and a second side plate 260. The casing 200 has an almost rectangular parallelepiped shape.

The bottom plate 210 is installed facing the installation surface of the casing 200. The top plate 220 is provided on the opposite side of the bottom plate 210. The front plate 230 has the transmission area 231. The rear plate 240 is provided on the opposite side of the front plate 230. The first side plate 250 and the second side plate 260 are the rest of the side plates.

Note that the projection display apparatus 100 has a size of a PET bottle having a volume of 200 ml to 2 l. For example, if the volume of the projection display apparatus 100 is about 900 ml then its weight is about 800 g. The size of the image displayed by the projection display apparatus 100 is about 20 inches, for example. It should be noted that the distance between the projection display apparatus 100 and the projection plane is very close.

### (Configuration of Projection Display Apparatus)

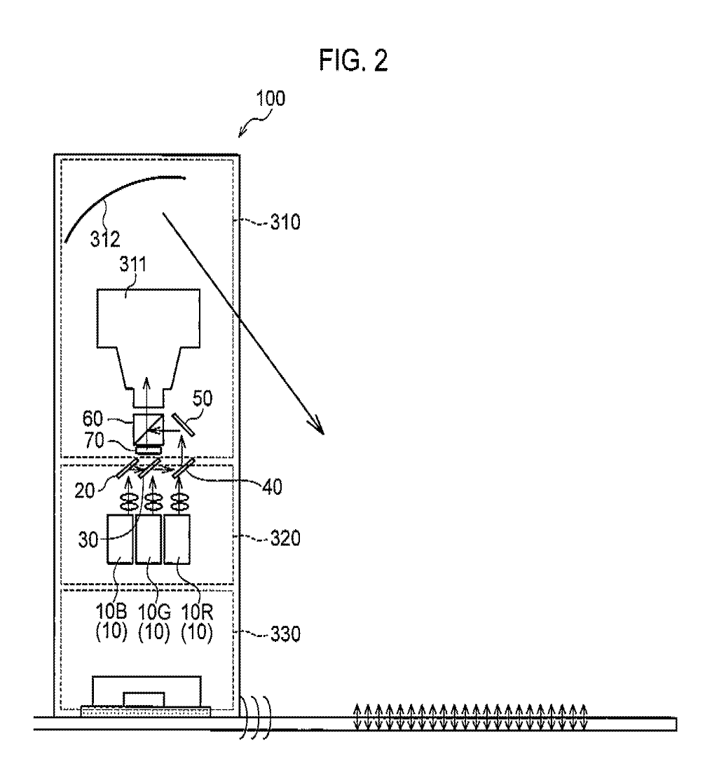

Hereinafter, the configuration of the projection display apparatus according to the first embodiment is described with reference to drawings. FIG. 2 is a diagram (side view) illustrating the configuration of the projection display apparatus 100 according to the first embodiment.

As shown in FIG. 2, the projection display apparatus 100 includes: the projection unit 310; a light source unit 320; and an acoustic device 330. More specifically, the projection display apparatus 100 includes: the light source 10 (a light source 10R, a light source 10G, and a light source 10B); a mirror 20; a dichroic mirror 30; a dichroic mirror 40; a mirror 50; a PBS cube 60; a reflective liquid crystal panel 70; a projection lens group 311; and a reflection mirror 312.

The light source 10 respectively outputs a plurality of color component light beams. Further, a heat sink to dissipate the heat generated in the light source 10 can also be annexed in the light source 10.

The light source 10R is a light source from which red component light R emits, and is a red Light Emitting Diode (LED) or a red Laser Diode (LD), for example. A heat sink made from a member having excellent heat dissipation properties such as a metal can be annexed in the light source 10R.

The light source 10G is a light source from which green component light G emits, and is a green LED or a green LD, for example. A heat sink made from a member having excellent heat dissipation properties such as a metal can be annexed in the light source 10G.

The light source 10B is a light source from which blue component light B emits, and is a blue LED or a blue LD, for example. A heat sink made from a member having excellent heat dissipation properties such as a metal can be annexed in the light source 10B.

The mirror 20 reflects the blue component light B emitted from the light source 10B.

The dichroic mirror 30 reflects the green component light G emitted from the light source 10G and transmits the blue component light B emitted from the light source 10B.

The dichroic mirror 40 reflects the green component light G and the blue component light B and transmits the red component light R emitted from the light source 10R.

In this way, the dichroic mirror 30 and the dichroic mirror 40 combines the light source 10R, the green component light G, and the blue component light B.

The mirror 50 reflects the light source 10R, the green component light G, and the blue component light B.

The PBS cube 60 reflects the light of the first polarized light of the PBS cube 60 (for example, S polarized light) and transmits the light of the second polarized light of the PBS cube 60 (for example, S polarized light). More specifically, PBS cube 60 reflects the light which is reflected by mirror 50 to the side of the reflective liquid crystal panel 70. On the other hand, the PBS cube 60 transmits the light emitted from the reflective liquid crystal panel 70.

The reflective liquid crystal panel 70 modulates the light reflected by the PBS cube 60 and also reflects the modulated light to side of the PBS cube 60. The light emitted from the reflective liquid crystal panel 70 is the light of the second polarized light (For example, S polarized light) of the PBS cube 60.

The projection lens group 311 outputs the image light that is output from the reflective liquid crystal panel 70, to the side of the reflection mirror 312. The projection lens group 311 includes a lens which has an almost circular shape that is around the optical axis of the projection unit 310 and another lens which has a part of an almost circular shape (for example, a semicircular shape in the lower half) that is around the optical axis of the projection unit 310.

It should be noted that the diameter of the lens included in the projection lens group 311 is larger as it is located nearer the reflection mirror 312.

The reflection mirror 312 reflects the image light emitted from the reflective liquid crystal panel 70 to the projection plane side. The reflection mirror 312 is an aspherical mirror with a concave face on the side of the reflective liquid crystal panel 70, for example.

In the first embodiment, the projection unit 310 includes a projection lens group 311 and a reflection mirror 312. The light source unit 320 includes at least a light source 10. Note that the light source unit 320 may also include other components (for example, a mirror 20, a dichroic mirror 30, a dichroic mirror 40).

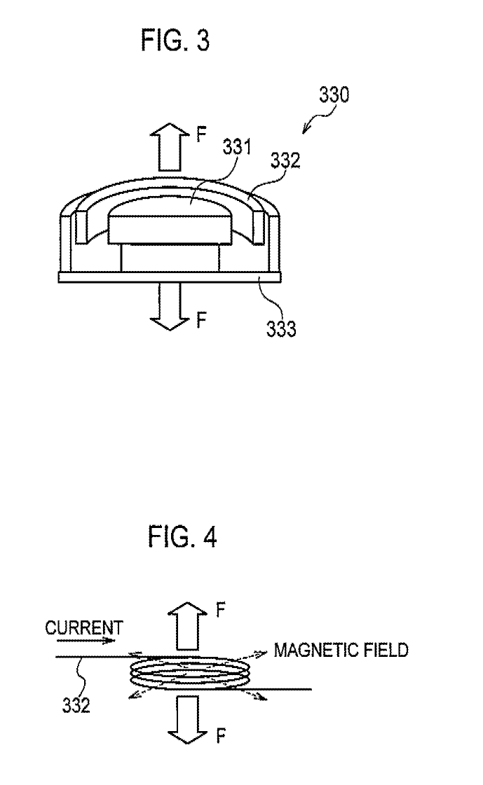

The acoustic device 330 outputs the sound in the vertical direction. Specifically, as shown in FIG. 3, the acoustic device 330 has a magnet 331, a coil 332, and a vibration plate 333.

As shown in FIG. 4, the acoustic device 330 changes the magnetic field around the magnet 331 by switching the orientation of the current flowing through the coil 332. As a result, the vibration plate 333 fixed on the magnet 331 vibrates.

### (Example of Arranging Acoustic Device)

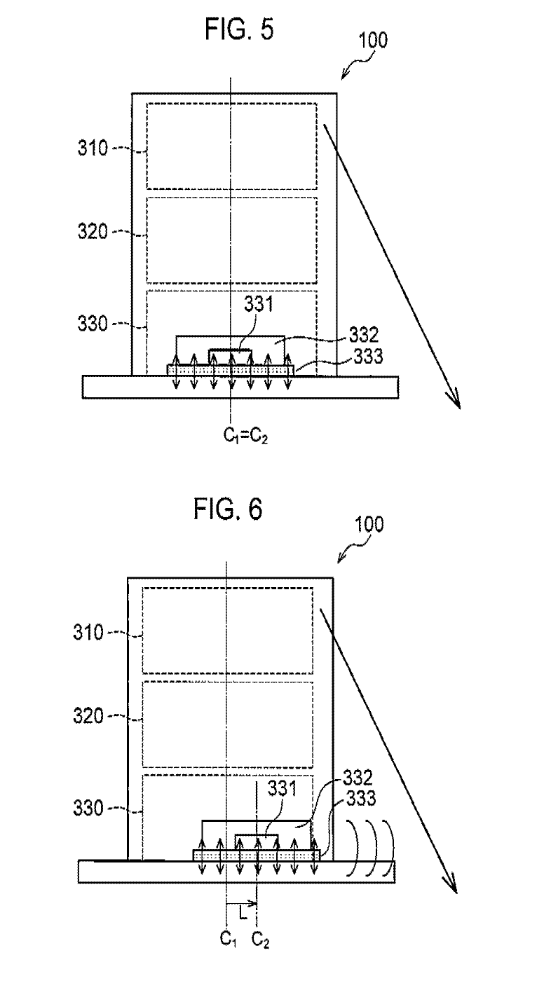

An example of arranging the acoustic device according to the first embodiment is explained as follows with reference to the drawings. FIG. 5 to FIG. 8 are diagrams showing the arrangement of the acoustic device 330 according to the first embodiment. Note that FIG. 5 to FIG. 8 are diagrams of the projection display apparatus 100 seen from the side. Further, in FIG. 5 to FIG. 8, in the side view of the projection display apparatus 100, the center of the projection display apparatus 100 is shown as C₁ and the sound source (center of the magnet 331) of the acoustic device 330 is shown as C₂.

For example, the acoustic device 330 is placed on the bottom surface of the projection display apparatus 100 as shown in FIG. 5. In FIG. 5, the acoustic device 330 outputs the sound by transferring the 1.0 vibrations of the vibration plate 333 to the installation surface. Further, the position of the sound generator C₂ (center of the magnet 331) of the acoustic device 330 is the same as that of the center C₁ of the projection display apparatus 100. Therefore, vibrations (sound) of the vibration plate 333 spread concentrically from the center of the projection display apparatus 100.

Alternatively, the acoustic device 330 is placed on the bottom surface of the projection display apparatus 100 as shown in FIG. 6. In FIG. 6, the acoustic device 330 outputs the sound by transferring the vibrations of the vibration plate 333 to the installation surface. Further, the sound generator C₂ (center of the magnet 331) of the acoustic devices 330 is shifted to the projection plane side by distance L with respect to the center C₁ of the projection display apparatus 100. Therefore, vibrations (sound) of the vibration plate 333 spread with directivity toward the projection plane side.

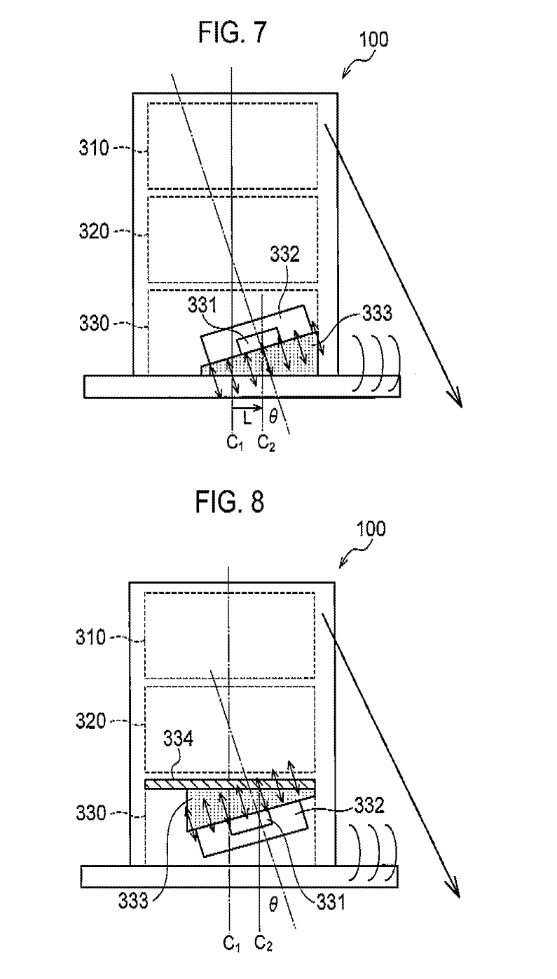

Alternatively, the acoustic device 330 is placed on the bottom surface of the projection display apparatus 100 as shown in FIG. 7. In FIG. 7, the acoustic device 330 outputs the sound by transferring the vibrations of the vibration plate 333 to the installation surface. Further, the sound generator C₂ (center of the magnet 331) of the acoustic devices 330 is shifted to the projection plane side by distance L with respect to the center C₁ of the projection display apparatus 100. Furthermore, the magnet 331 is placed so that the bottom surface of the magnet 331 makes an angle 8 with respect to the horizontal plane. Note that the magnet 331 is placed so that the bottom surface of the magnet 331 is lowered toward the opposite side (the side of the rear plate 240) of the projection plane from the projection plane side (the side of the front plate 230). Therefore, vibrations (sound) of the vibration plate 333 spread with directing toward the projection plane side.

Alternatively, the acoustic device 330 is placed right under the light source unit 320 as shown in FIG. 8. In FIG. 8, the acoustic device 330 has a reverberating plate 334 facing the installation surface and outputs the sound by the reverberation of sound that is generated from the vibrations of the vibration plate 333 by the reverberating plate 334. The sound generator C₂ (center of the magnet 331) of the acoustic device 330 is shifted to the projection plane side by distance L with respect to the center C₁ of the projection display apparatus 100. Furthermore, the magnet 331 is placed so that the bottom surface of the magnet 331 makes an angle θ with respect to the horizontal plane. Note that the magnet 331 is placed so that the bottom surface of the magnet 331 is lowered toward the opposite side (the side of the rear plate 240) of the projection plane from the projection plane side (the side of the front plate 230). Therefore, the sound reverberated by the reverberating plate 334 spreads with directing toward the projection plane side.

Note that the reverberating plate 334 can be provided on the light source unit 320 instead of the acoustic device 330.

### (Operation and Effect)

In the first embodiment, since the acoustic device 330 outputs the sound with directing in the vertical direction, the mixing of the sounds output from the acoustic device 330 can be inhibited.

In the first embodiment, the acoustic device 330 outputs the sound by transferring the vibrations of the vibration plate 333 to the installation surface. In such a case, when highly coherent light source 10 (for example, LD; Laser Diode) is used, it is possible to reduce the speckle noise caused due to the vibrations of the installation surface including the projection plane.

### [Modification 1-1]

A modification 1-1 of the first embodiment is described, below. Mainly the differences from the first embodiment are described, below.

In the first embodiment, the acoustic device 330 outputs the sound by switching the direction of the current flowing through the coil 332. On the other hand, the acoustic device 330 in the modification 1-1 is a speaker, for example. Note that the acoustic device 330 outputs the sound in the vertical direction.

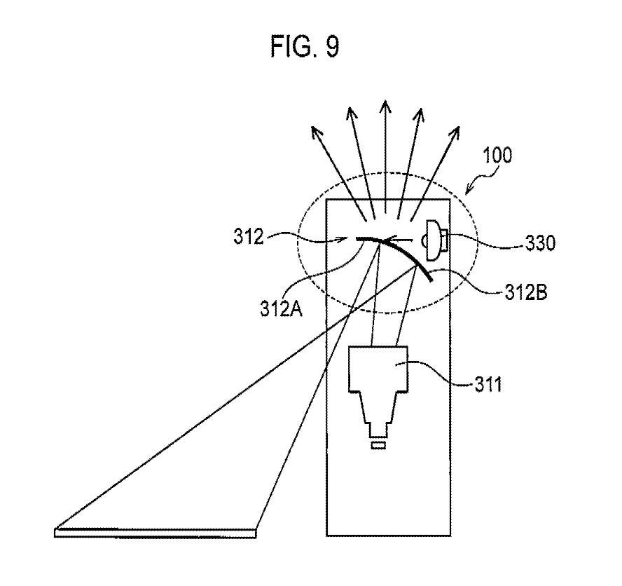

More specifically, as shown in FIG. 9, the reflection mirror 312 has a mirror surface 312A that reflects the light emitted from the reflective liquid crystal panel 70 and a rear surface 312E provided on the opposite side of the mirror surface 312A.

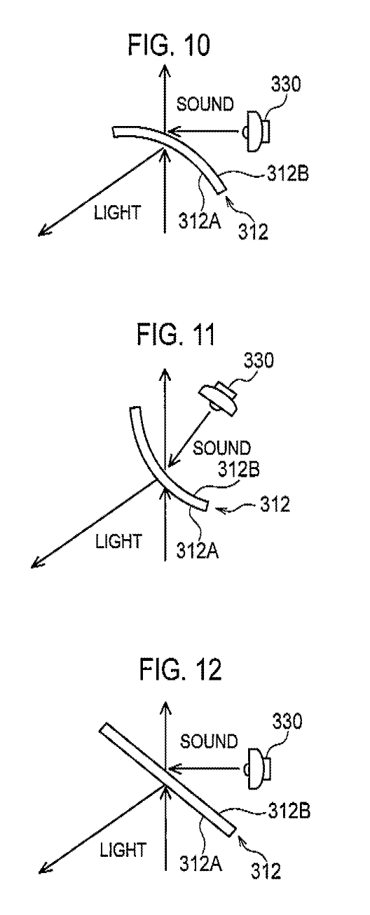

The acoustic device 330 outputs the sound in the vertical direction by reverberating the sound by the rear surface 312B. Note that, as shown in FIG. 10, the reflection mirror 312 can be a concave mirror having the concave face on the side of the reflective liquid crystal panel 70. As shown in FIG. 11, the reflection mirror 312 can be a convex face mirror having the convex face on the side of the reflective liquid crystal panel 70. The reflection mirror 312 can be a flat mirror as shown in FIG. 12. As shown in FIG. 10 to FIG. 12 depending on the type of the reflection mirror 312, obviously the placement of the acoustic devices 330 differs.

### Second Embodiment

Hereinafter, a second embodiment will be explained. Mainly the differences from the first embodiment are described, below.

In the first embodiment, the acoustic device 330 outputs the sound by switching the direction of the current flowing through the coil 332. Further, the acoustic device 330 outputs the sound in the vertical direction.

On the other hand, the acoustic device 330 in the second embodiment is a speaker, for example. Further, the acoustic device 330 outputs the sound toward the projection plane.

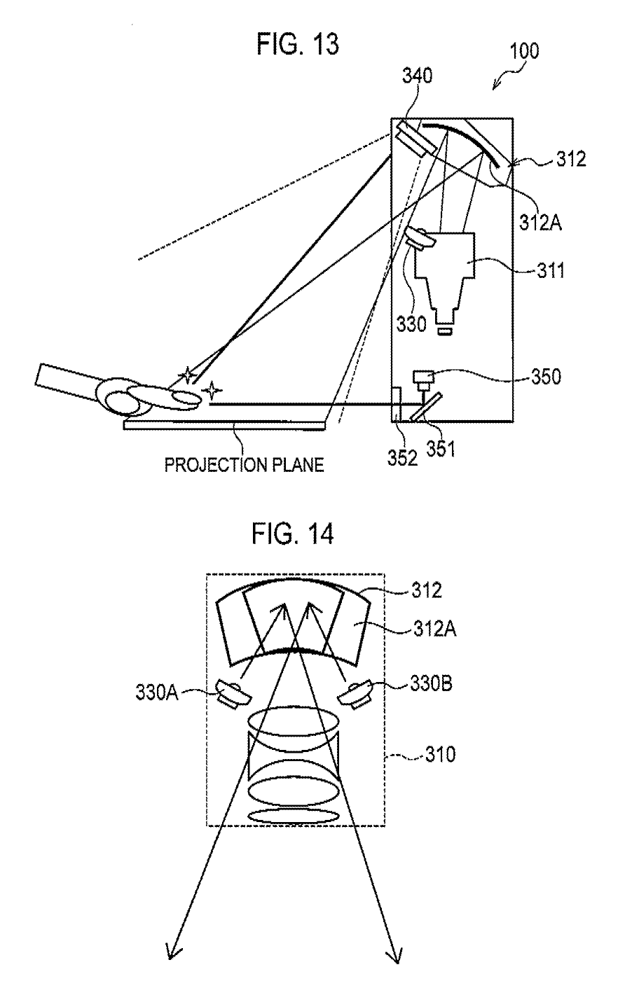

Specifically, as shown in FIG. 13, the projection display apparatus 100 includes an imaging device 340 or a detection unit 350 in addition to the components shown in FIG. 2. Note that the projection display apparatus 100 is attached to the detection unit 350 and includes a mirror 351 and a diffusion lens 352.

The imaging device 340 is imaging devices such as a camera. The imaging device 340 detects the position of the user by taking an image of the projection plane side. It is preferable that the range imaged by the imaging device 340 is larger than the projection plane.

The detection unit 350 has a light emitting unit that emits a laser light beam and a light receiving unit that receives the reflected light of the laser light. The detection unit 350 detects the position of the user by receiving the laser light reflected by the user.

Note that the mirror 351 reflects the laser light to the projection plane side and then reflects the reflected light of the laser light to the side of the detection unit 350. The diffusion lens 352 diffuses the laser light and then focuses the reflected light of the laser light. Note that it is preferable that the range of the laser light diffused by the diffusion lens 352 is larger than the projection plane.

Note that in second embodiment, both the imaging device 340 and the detection unit 350 are installed but installing only one of them is also possible.

At this point, in second embodiment, the acoustic device 330 outputs the sound toward the projection plane by reverberating the sound by the mirror surface 312A of the reflection mirror 312.

Further, in second embodiment, as shown FIG. 14, an acoustic device 330A and an acoustic device 330B are installed as the acoustic device 330. Note that FIG. 14 shows the projection display apparatus 100 (projection unit 310) seen from the front.

The acoustic device 330A is placed on the first side surface (for example, first side plate 250) side. The acoustic device 330B is placed on the second side surface (for example, second side plate 260) side. It is necessary to note that, since the sounds output from acoustic device 330A and acoustic device 330B are reverberated by the mirror surface 312A of the reflection mirror 312, they intersect each other.

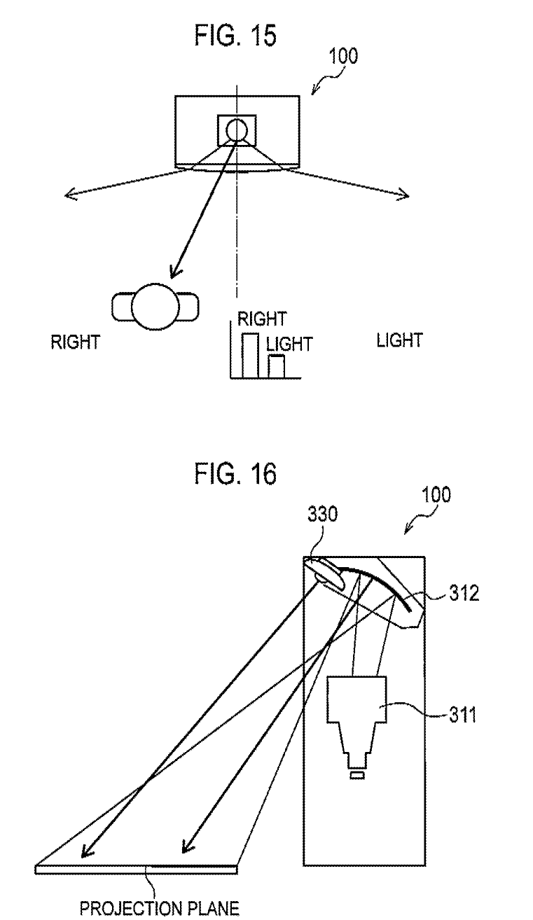

Further, sound output from the acoustic device 330A and the acoustic device 330B can be mutually independently controlled. For example, as shown in FIG. 15, when the detection unit 350 (or imaging device 340) detects that the user is positioned on the right side, as seen from the projection display apparatus 100, the sound of the right side is increased than that of the left side. In the example shown in FIG. 14, the sound output from the acoustic device 330B is increased than the sound output from the acoustic device 330A.

### (Operation and Effect)

In the second embodiment, since the acoustic device 330 outputs the sound with directivity toward the projection plane, the mixing of the sounds output from the acoustic devices 330 can be inhibited.

In the second embodiment, the acoustic device 330A and the acoustic device 330B are installed as acoustic device 330 and the sound output from acoustic device 330A and the acoustic device 330B can be mutually and independently controlled. Therefore, the directivity of sound can be adjusted arbitrarily.

In second embodiment, since the function (imaging device 340 or detection unit 350) to detect the position of the user is provided, the directivity of the sound can be adjusted according to the position of the user.

### [Modification 2-1]

A modification 2-1 of the second embodiment is described, below. Mainly the differences from the second embodiment are described, below.

In the second embodiment, the acoustic device 330 outputs the sound toward the projection plane by the reverberation of sound by the mirror surface 312A of the reflection mirror 312. On the other hand, in the modification 2-1, the acoustic device 330 outputs the sound directly toward the projection plane, without using the reverberation of sound.

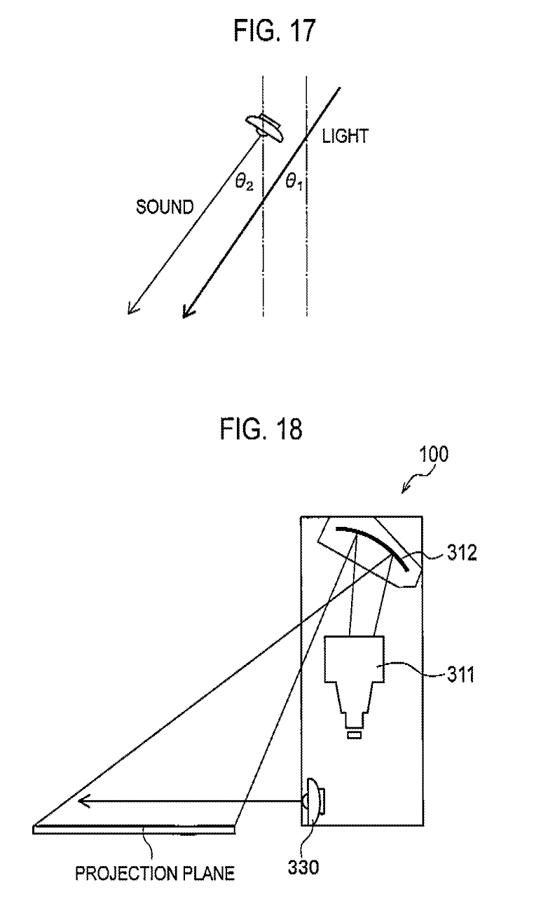

More specifically, as shown in FIG. 16, the acoustic device 330 is provided on the upper part of the projection display apparatus 100 and it directly outputs the sound toward the projection plane. Further, as shown in FIG. 17, it is preferable that angle θ₁. forming the light reflected by the reflection mirror 312 with the vertical line and angle θ₂ forming the direction in which sound is output from the acoustic device 330 with the vertical line, are almost same.

### [Modification 2-2]

The modification 2-2 of the second embodiment is described, below. Mainly the differences from the second embodiment are described, below.

In the second embodiment, the acoustic device 330 outputs the sound toward the projection plane by the reverberation of sound by the mirror surface 312A of the reflection mirror 312. On the other hand, in the modification 2-2, the acoustic device 330 outputs the sound directly toward the projection plane without using the reverberation of sound.

Specifically, as shown in FIG. 18, the acoustic device 330 is provided on the lower part of the projection display apparatus 100 and it directly outputs the sound toward the projection plane. More particularly, the acoustic device 330 outputs the sound in the horizontal direction toward the projection plane.

### Other Embodiments

The present invention is explained through the above embodiments, but it must not be assumed that this invention is limited by the statements and drawings constituting a part of this disclosure. From this disclosure, various alternative embodiments, examples, and operational technologies will become apparent to those skilled in the art.

In the embodiments, the reflective liquid crystal panel is simply illustrated as an imager. The imager can be a Digital Micromirror Device (DMD) or a transmissive liquid crystal panel.

Although, it is not specifically mentioned in the first embodiment, the modification 1-1, the modification 2-1, and the modification 2-2, a plurality of acoustic devices can be installed as an acoustic device 330 in these embodiments. In such a case, the sounds output from the plurality of acoustic devices can be mutually and independently controlled.

Although, it is not specifically mentioned in the first embodiment, the modification 1-1, the modification 2-1, and the modification 2-2, the function (imaging device 340 or detection unit 350) to detect the position of user can be provided in these embodiments.

In the embodiments described above, a case in which the acoustic device 330 includes the vibration plate 333 has been illustrated. However, the acoustic device 330 can be used without the vibration plate 333. For example, the acoustic device 330 can output the sound by causing the bottom plate 210 of the casing 200 to vibrate.

1. A projection display apparatus placed on an installation surface forming a horizontal plane and projecting an image onto a projection plane provided on a horizontal plane, comprising:
an imager that modulates the light emitted from a light source;
an projection unit that projects the light emitted from the imager onto the projection plane; and
an acoustic device that outputs a sound in the vertical direction.

2. The projection display apparatus according to claim 1, wherein the acoustic device outputs the sound by the vibrations of the installation surface.

3. The projection display apparatus according to claim 1, comprising a reverberating plate facing the installation surface, wherein the acoustic device outputs the sound generated from the vibrations of a vibration plate by reverberating the sound with the reverberating plate.

4. The projection display apparatus according to claim 1, wherein
the projection unit comprises a reflection mirror having a mirror surface for reflecting the light emitted from the imager onto the projection plane side and a rear surface, and
the acoustic device outputs the sound in the vertical direction by reverberating the sound on the rear surface of the reflection mirror.

5. The projection display apparatus according to claim 1, wherein
the acoustic device, when seen from the front of the projection display apparatus, comprises a first sound output unit provided on the first side-surface side and a second sound output unit provided on the second side-surface side, and
the sounds output from the first sound output unit and the second sound output unit are mutually independently controlled.

6. A projection display apparatus placed on an installation surface forming a horizontal plane and projecting an image onto a projection plane provided on a horizontal plane, comprising:
an imager that modulates the light emitted from a light source;
an projection unit that projects the light emitted from the imager onto the projection plane; and
an acoustic device that outputs the sound toward the projection plane.

7. The projection display apparatus according to claim 6, wherein
the projection unit comprises a reflection mirror having a mirror surface for reflecting the light emitted from the imager onto the projection plane side, and
the acoustic device outputs the sound toward the projection plane by reverberating the sound on the mirror surface of the reflection mirror.

8. The projection display apparatus according to claim 6, wherein the acoustic device directly outputs the sound toward the projection plane without using the reverberation of sound.

9. The projection display apparatus according to claim 6, wherein
the acoustic device, when seen from the front of the projection display apparatus, comprises a first sound output unit provided on the first side-surface side and a second sound output unit provided on the second side-surface side, and
the sounds output from the first sound output unit and the second sound output unit are mutually independently controlled.
